(19) United States
(12) Patent Application Publication
(10) Pub. No.: US 2013/0311066 A1
(43) Pub. Date: Nov. 21, 2013

(54) METHOD AND SYSTEM FOR ENGINE CONTROL

(71) Applicants: Leonardo da Mata Guimaraes, Contagem (BR); Ronald Gene Billig, Grove City, PA (US)

(72) Inventors: Leonardo da Mata Guimaraes, Contagem (BR); Ronald Gene Billig, Grove City, PA (US)

(21) Appl. No.: 13/473,788

(22) Filed: May 17, 2012

(51) Int. Cl. F02D 41/30

(52) U.S. Cl. 701/104

(57) ABSTRACT

Methods and systems are provided for a vehicle engine. One example method comprises delivering a first fuel to an engine cylinder at least partially during an intake stroke, and initiating combustion in the cylinder via injection of a second fuel into the cylinder. Responsive to an indication of uncontrolled combustion of pre-mixed first fuel and air in the cylinder, wherein the uncontrolled combustion is onset by the initiated combustion of the second fuel, amounts of the first fuel relative to the second fuel in the cylinder are adjusted.

### BACKGROUND

Embodiments of the subject matter disclosed herein relate to a method and system for mitigating uncontrolled engine combustion events.

### DISCUSSION OF ART

Vehicle engines may operate with one or more fuels. These may include alternate fuels that have been developed to mitigate the rising prices of conventional fuels and to reduce exhaust emissions. As an example, a vehicle engine may be configured to operate with a compression ignitable fuel such as diesel and another fuel, such as natural gas. While operating with multiple fuels together in the engine cylinder can provide various advantages, there is also the potential that power improvements, reductions in fuel consumption, and/or reduction in exhaust emissions can be limited by uncontrolled combustion events.

### BRIEF DESCRIPTION

Methods and systems are provided for mitigating uncontrolled combustion in a vehicle engine operating with a first fuel, such as a gaseous fuel, and a second fuel, such as a liquid fuel, these fuels being provided as a non-limiting example. One exemplary embodiment comprises delivering a first fuel to an engine cylinder at least partially during an intake stroke, initiating combustion in the cylinder via stratified injection of a second fuel into the cylinder, and adjusting amounts of the first fuel relative to the second fuel in the cylinder responsive to an indication of uncontrolled combustion of pre-mixed first fuel and air in the cylinder, where the uncontrolled combustion is onset by the initiated combustion of the second fuel.

As used herein, uncontrolled combustion includes auto-ignition of end gasses in the cylinder, which may include a mixture of the first fuel and air. The auto-ignition may be caused by compression ignition combustion of the second fuel. For example, compression ignition combustion of stratified fuel may generate a primary flame front that increases pressure and temperature of remaining end gasses (including a mixture of air and the first fuel) in the cylinder to the point of auto-ignition. The resulting flame front of the end gasses then collides with the primary flame front and generates noise and vibration, as well as reduced engine torque, for a given amount of the fuels. By adjusting amounts of the first fuel and the second fuel responsive to the indication of uncontrolled combustion, it is possible to reduce the auto-ignition of the end gasses. For example, by enleaning the air-fuel ratio of the end gas mixture, uncontrolled combustion is reduced and overall engine performance is improved, while at the same time engine torque and/or power is maintained by appropriately increasing the amount of the second fuel that is injected.

This brief description is provided to introduce a selection of concepts in a simplified form that are further described below. This brief description is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an exemplary embodiment of a vehicle system including a first vehicle housing a vehicle engine and a second fuel storage vehicle wherein a gaseous fuel is stored.

FIG. 2 shows an exemplary embodiment of an engine system used in the vehicle system of FIG. 1.

FIGS. 3-4 show high level flow charts of a method for adjusting first and second fuel injection amounts responsive to an indication of uncontrolled cylinder combustion.

FIG. 5 shows another exemplary embodiment of the engine system used in the vehicle system of FIG. 1 including donor and non-donor cylinder groups.

FIG. 6 shows a high level flow chart of a method for differentially adjusting first and second fuel injection amounts in donor and non-donor cylinder groups responsive to an indication of uncontrolled cylinder combustion.

### DETAILED DESCRIPTION

The following description relates to methods and systems for mitigating uncontrolled cylinder combustion in an engine operating with a plurality of fuels present in the cylinder.

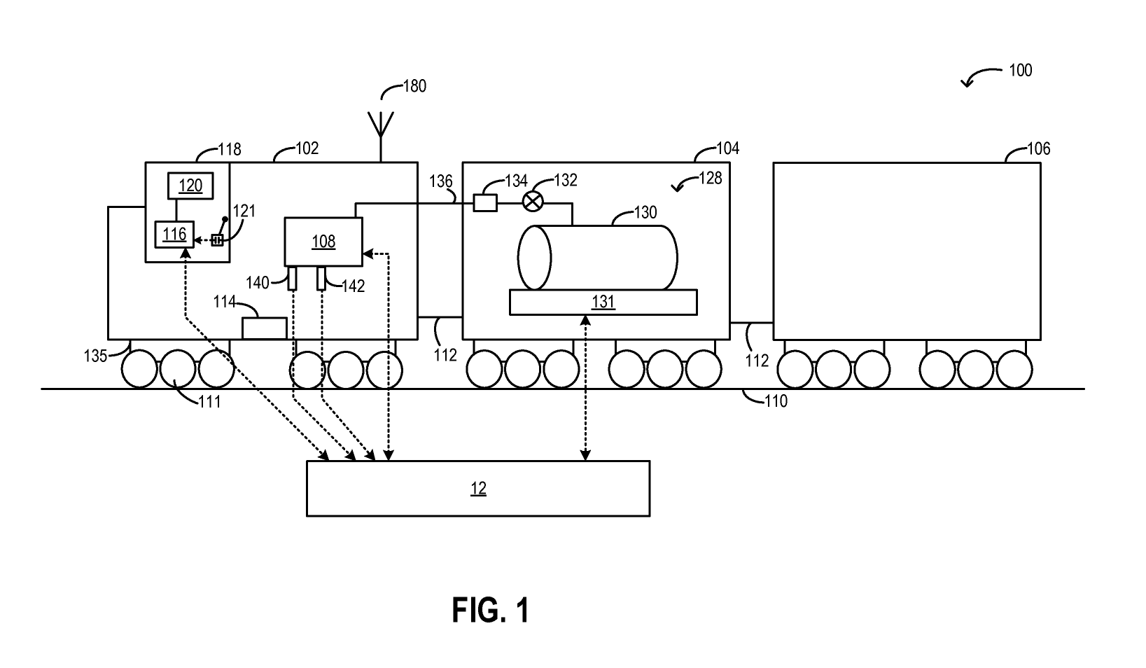

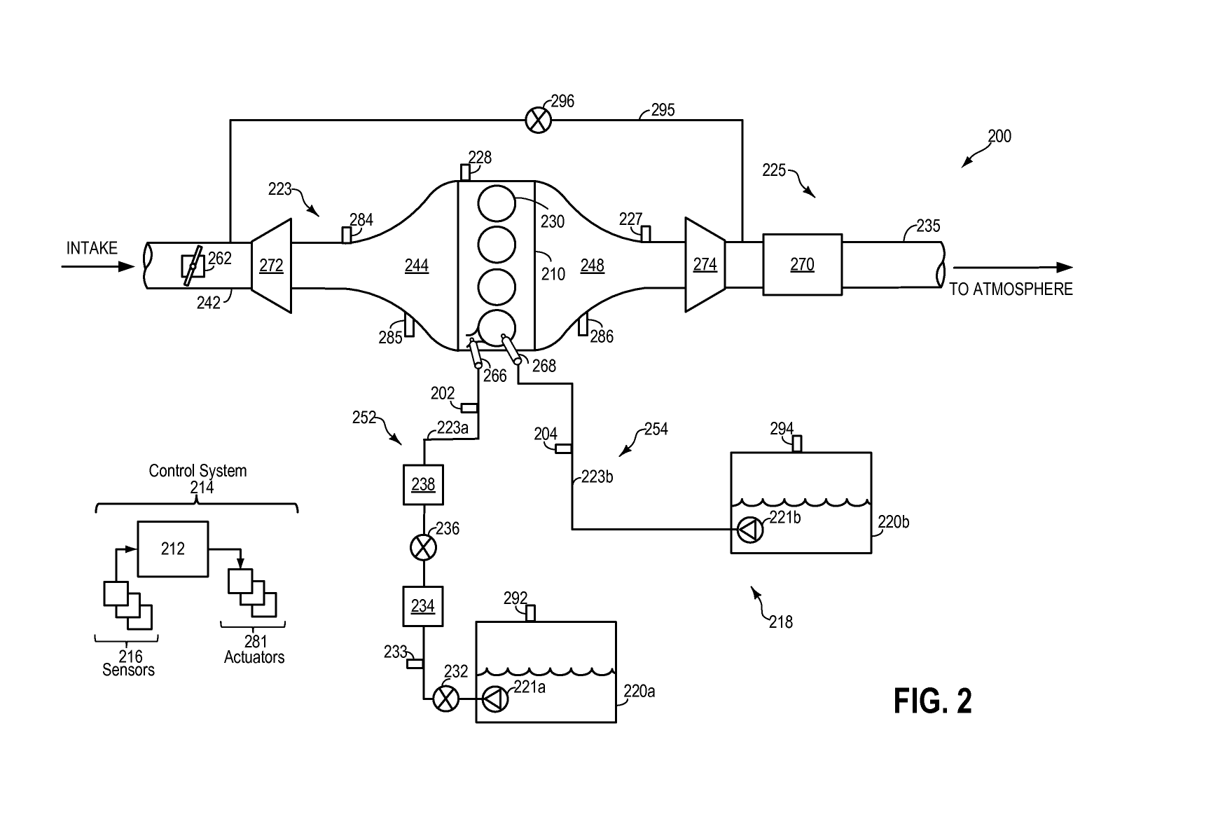

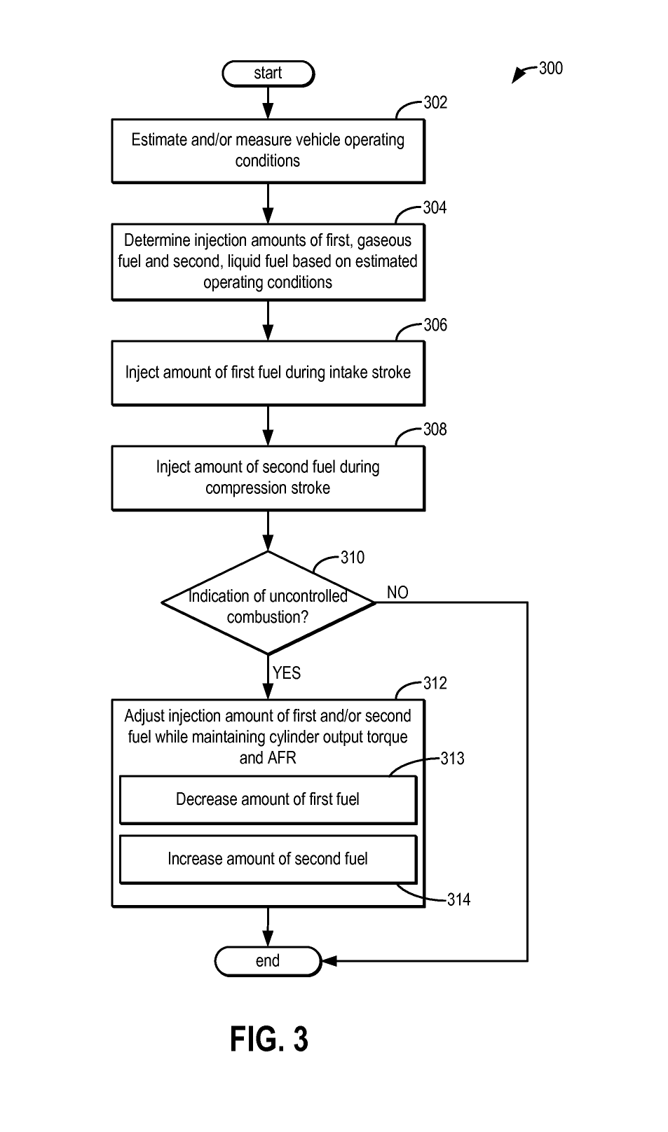

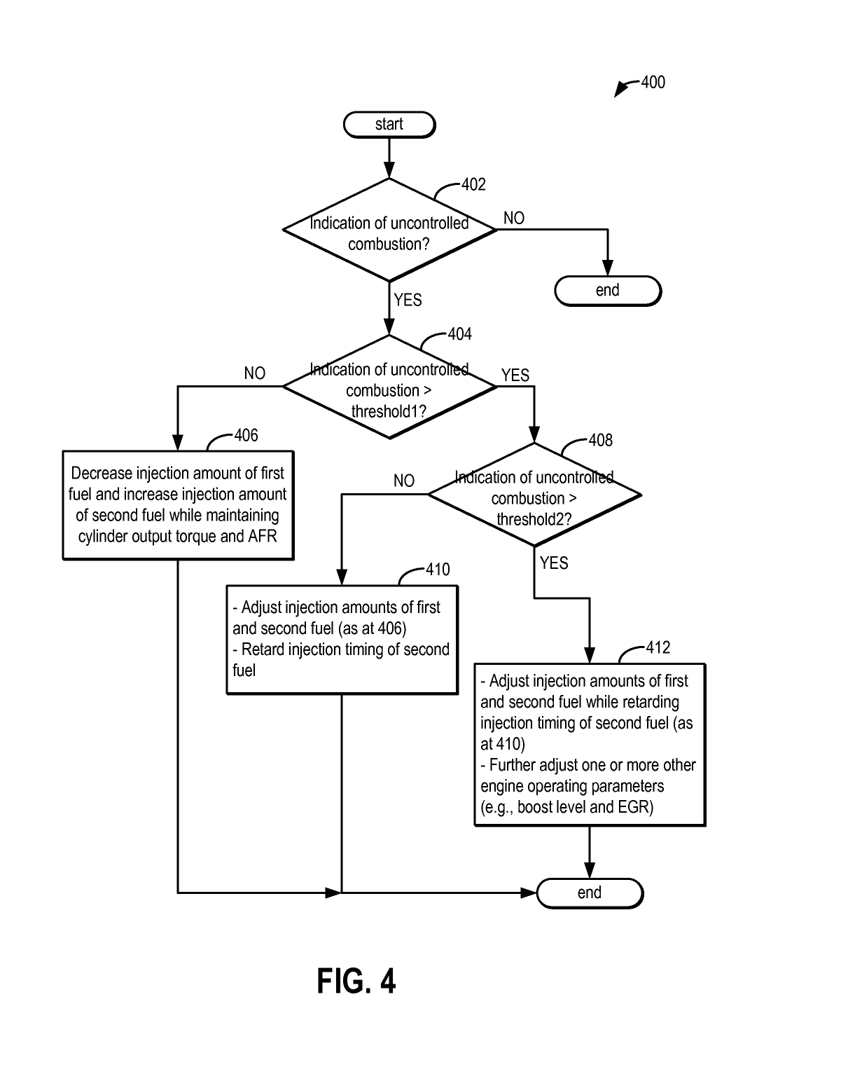

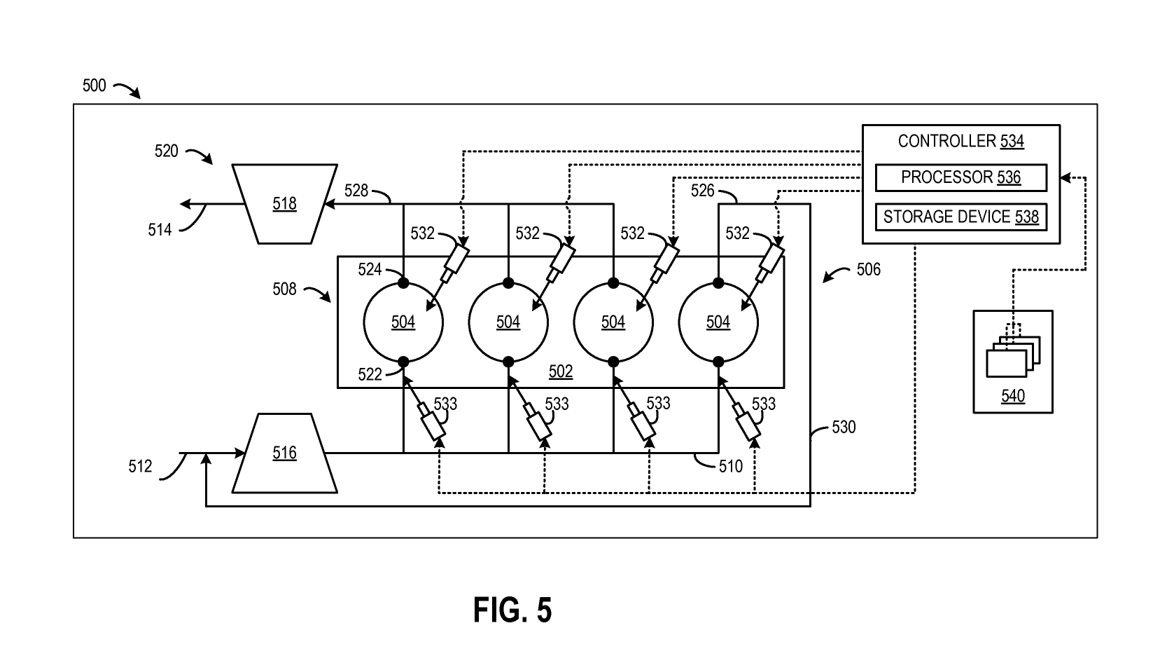

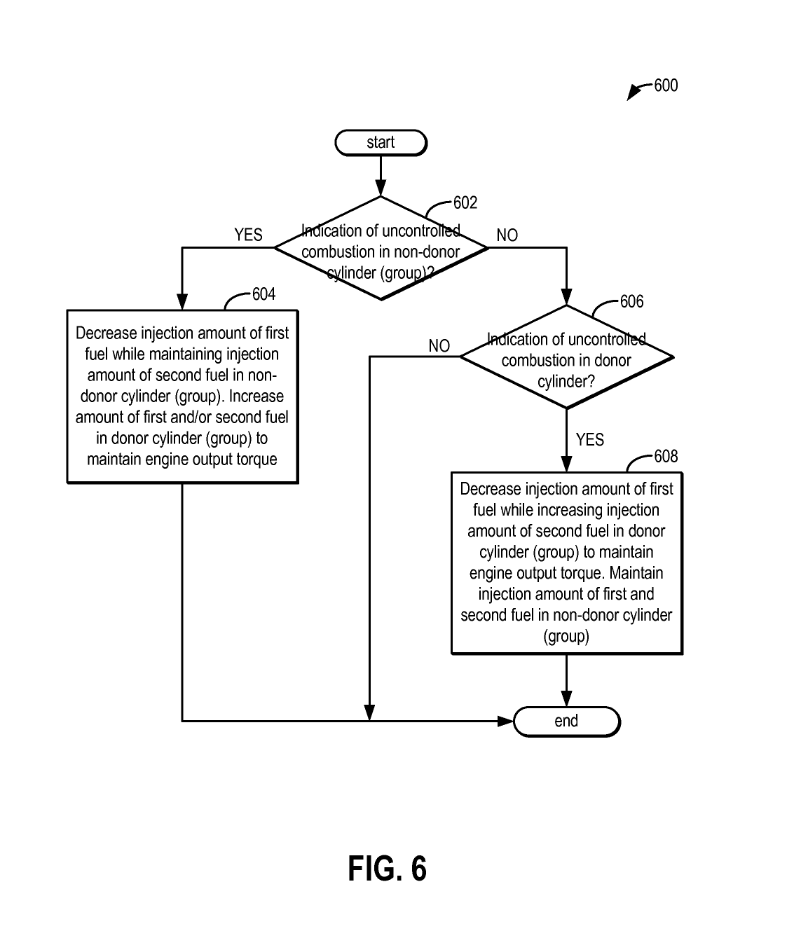

Vehicles, such as the rail vehicle system of FIG. 1, may be operated with one or more fuels. For example, the vehicle may be configured with an engine system, as shown in FIGS. 2 and 5, that can be operated on each of a first, gaseous fuel (such as compressed natural gas), and a second, liquid fuel (such as diesel fuel). As shown in FIG. 3, a vehicle control system may be operable to adjust a fuel injection to an engine cylinder in response to an indication of uncontrolled combustion in the cylinder. Specifically, in response to uncontrolled combustion of a pre-mixed air-fuel mixture of the first gaseous fuel in the cylinder onset by a stratified injection of the second liquid fuel, the controller may temporarily reduce injection of the gaseous fuel while increasing injection of the liquid fuel in the affected cylinders. As shown in FIG. 4, based on the intensity of the indication (relative to one or more thresholds), the fuel amount adjustment may be combined with injection timing adjustments as well as adjustments to other engine operating parameters. In engine systems configured with donor and non-donor cylinder groups, such as the engine system of FIG. 5, differential first and second fuel injection adjustments may be performed based on whether the indication of uncontrolled combustion is in a donor cylinder group or a non-donor cylinder group (FIG. 6). In this way, uncontrolled cylinder combustion can be mitigated while enabling fuel economy benefits from using the plurality of fuels to be achieved.

As used herein, gaseous fuel refers to a fuel that is gaseous at atmospheric conditions and/or upon injection into the engine intake or engine cylinder, but which may be stored and/or routed to the engine in liquid form (at a pressure above saturation pressure). For example, the gaseous fuel may be stored in liquid form, delivered to the engine fuel rail in liquid form, but then injected into an engine cylinder in gaseous form.

FIG. 1 depicts an example vehicle system, depicted herein as train 100. Train 100 includes a first vehicle 102 (depicted herein as a rail vehicle, which may be a locomotive), and a second fuel storage vehicle 104 (depicted herein as a tandem rail car). Train 100 may include one or more additional cars 106 (one depicted in the present example). First vehicle 102, second fuel storage vehicle 104, and car 106 are configured to run on track 110. In alternate embodiments, any appropriate number of locomotives and cars may be included in train 100.

First vehicle 102 is powered for propulsion, while second vehicle 104 and car 106 are non-powered. An engine system 108 is disposed in first vehicle 102, the engine system comprising an engine with a plurality of cylinders. Each cylinder is configured to have at least one port fuel injector and at least one direct fuel injector. In the depicted example, first vehicle 102 is configured as a locomotive powered by engine system 108 (elaborated at FIG. 2) that operates with various fuels, such as a first fuel and a second fuel. The fuels may include a liquid fuel, such as diesel fuel, an alternative fuel, and/or a gaseous fuel, or combinations thereof. In one example, a first fuel includes a gaseous fuel and a second fuel includes diesel fuel. Further, the gaseous fuel may be an alternative fuel, such as compressed natural gas (CNG), liquid natural gas (LNG) and/or combinations thereof.

In some embodiments, first vehicle 102 may be powered via alternate engine configurations, such as a gasoline engine, a biodiesel engine, a natural gas engine, or wayside (e.g., catenary, or third-rail) electric, for example. While engine system 108 is configured in one embodiment herein as a multi-fuel engine operating with diesel fuel and CNG/LNG, in alternate examples, engine system 108 may use various combinations of fuels other than diesel and CNG/LNG.

First vehicle 102 is mechanically coupled to second fuel storage vehicle 104 via coupler 112. Likewise, second fuel storage vehicle 104 is mechanically coupled to car 106 via coupler 112. In this way, first vehicle 102, second fuel storage vehicle 104, and car 106 form a consist.

Second fuel storage vehicle 104 comprises a fuel system 128 including a first, fuel tank 130 for storing the first (gaseous) fuel. First vehicle 102 comprises a second fuel tank (not shown) for storing the second (liquid) fuel. In one example, where the vehicle system is a train, the second fuel storage vehicle may be a tandem car mechanically coupled behind a lead locomotive. As elaborated below, train 100 further includes a fuel delivery line 136 linking first vehicle 102 and second fuel storage vehicle 104 for transfer if the first, gaseous fuel from the fuel storage vehicle to the first vehicle.

First fuel tank 130 is configured for storing the first fuel in either a liquid or gaseous state. As elaborated at FIG. 2, the first fuel may be a gaseous fuel stored in first fuel tank 130 at saturation pressure and fuel system 128 may be configured as a liquid phase injection (LPI) system wherein the gaseous fuel is routed to an engine fuel rail at an elevated pressure relative to atmospheric pressure. In one example, the first fuel may be compressed natural gas fuel (CNG fuel) or liquefied petroleum gas fuel (LPG fuel). Herein, in the liquid phase injection system example, when stored at saturation pressure in fuel tank 130 supported by fuel storage vehicle 104, and while routed along a fuel line and fuel rail at high pressure, the fuel may be in liquid form (e.g., as LNG). However, when injected into the engine via the injectors into the cylinder at lower pressure (e.g., into a lower pressure (in comparison to rail pressure) fuel preparation area of the engine), the fuel may transition into a gaseous form and thus be injected in a gaseous state. By maintaining the fuel at higher pressure and in liquid form during at least a portion of the routing along the fuel line and into the fuel rail, metering of the fuel is facilitated. However, in other embodiment, the fuel rail may hold the fuel in a gaseous state.

In one exemplary embodiment, CNG or LNG is stored in the second fuel storage vehicle 104 (e.g., a tender car) on a platform system 131. The platform system 131 is configured to regulate and control a temperature and pressure of the gaseous fuel. Various filters, valves, intercoolers and control systems (as elaborated herein) may be assembled in the vicinity of the fuel tank (e.g., beside the fuel tank) in the platform system. The platform system may further connect to locomotive 102. For example, the platform system may include the fuel delivery line.

Various fuel system components, such as various valves, pressure regulators, filters, and sensors, may be coupled in fuel system 128 including a tank shut-off valve 132 which controls entry of fuel from fuel tank 130 into fuel delivery line 136 and pressure regulator 134 which controls a fuel rail pressure of the first gaseous fuel. As elaborated herein, based at least in part on a power level setting of the vehicle engine, an initial (unadjusted) amount of first fuel and second fuel delivered to the engine, as well as an initial ratio of first fuel relative to a second fuel, may be determined. The second fuel used herein may be a liquid fuel, such as diesel for example. The initial, unadjusted injection amounts of the first and the second fuel are injected before an indication of uncontrolled combustion is received. Then, in response to an indication of uncontrolled combustion in the cylinder, the first and/or second fuel amounts may be adjusted to mitigate the uncontrolled combustion.

A vehicle control system, or controller 12, may be configured to receive information from, and transmit signals to first vehicle 102 and second vehicle 104 of train 100. Controller 12 may receive signals from a variety of sensors on train 100 regarding engine and/or vehicle operating conditions, as elaborated herein, and may adjust vehicle and engine operations accordingly. For example, controller 12 is operable to determine an amount of fuel to be injected to each engine cylinder from each of the multiple fuel sources. The controller may then further adjust the fuel amounts injected to the engine cylinders in response to an indication of uncontrolled combustion and/or in response to the vehicle operating (or about to begin operating) in a defined condition. In one example, controller 12 may be in a local environment, such as on-board first vehicle 102. However, in an alternate example, controller 12 may be in a remote location, such as at a train dispatch center.

Engine system 108 generates a torque that is used by a system alternator (not shown) to generate electricity for subsequent propagation of train 100. Traction motors (not shown), mounted on a truck 135 below the first vehicle 102, provide tractive power for propulsion. In one example, as depicted herein, six inverter-traction motor pairs may be provided for each of six axle-wheel pairs 111 of first vehicle 102. The traction motors may also be configured to act as generators providing dynamic braking to brake first vehicle 102. In particular, during dynamic braking, each traction motor may provide torque in a direction that is opposite from the torque required to propel the first vehicle in the rolling direction thereby generating electricity. At least a portion of the generated electrical power may be routed to a system electrical energy storage device, such as a battery (not shown). Air brakes 114 making use of compressed air may also be used by first vehicle 102 for braking.

Operating crew and electronic components involved in vehicle systems control and management, such as an on-board diagnostics (OBD) system 116, may be housed within cab 118. OBD system 116 may be in communication with controller 12, for example through wire communication (not shown) or wireless communication 180.

A vehicle operator may also indicate a desired vehicle power level by adjusting a power level setting of the vehicle engine. In one example, the operator can adjust a power level setting (thereby also controlling vehicle speed and torque demand) of train 100 by adjusting throttle and/or brake settings. For example, first vehicle 102 may be configured with a stepped or “notched” throttle (not shown) with multiple throttle positions or “notches” including an idle notch corresponding to an idle engine operation and multiple power notches corresponding to progressively higher powered engine operation. The throttle may additionally have continuous dynamic braking notches for progressively higher braking demand. When in the idle power level setting (e.g., the idle notch position), engine system 108 may receive a reduced amount of total fuel from the multiple fuel sources enabling it to idle at low at RPM. Additionally, the traction motors may not be energized. To commence operation of the first vehicle, the operator may select a direction of travel by adjusting the position of reverser 121 which can be placed in a forward, reverse, or neutral position. Upon placing the reverser in either a forward or reverse direction, the operator may release brake 114 and move the throttle to a first lower power level setting (e.g., a first power notch) to energize the traction motors. As the power level setting is increased (e.g., as the throttle is moved to higher power notches), a fuel rate and total amount of fuel delivered to the engine is increased, resulting in a corresponding increase in power output and vehicle speed.

Train 100 may include various sensors for determining vehicle and engine operating conditions and communicating the same with OBD system 116 and/or controller 12. The various sensors may include at least one combustion sensor 140 and a crankshaft speed sensor 142 coupled to a body of the vehicle engine. The combustion sensor is configured to provide an indication regarding cylinder combustion conditions including an indication of uncontrolled combustion in a cylinder. The crankshaft speed sensor is configured to provide an indication regarding the crankshaft speed. Controller 12 may determine an indication of uncontrolled combustion in a given cylinder based on outputs received from each of combustion sensor 140 and crankshaft speed sensor 142. Other sensors on-board train 100 include track sensors (for providing an indication regarding track conditions such as track grade), location sensors (for providing an indication regarding a location of the train and geographical markers such as tunnels and bridges at or near the location of the train), various temperature and pressure sensors (for providing an indication regarding vehicle, engine, fuel tank, and ambient temperature and pressure conditions), particulate matter sensors (for providing an indication regarding a dust or soot level at the location of the train), etc. Controller 12 receives input data from the various sensors, processes the input data, and triggers various actuators in response to the processed input data based on instruction or code programmed therein corresponding to one or more routines. The various actuators may include fuel injectors, throttles, various valves (such as tank shut-off valve 132), various pressure regulators (such as pressure regulator 134), etc. Example control routines are described herein with regard to FIGS. 3, 4, and 6.

In one example, the control system is operable to determine an amount of a first, gaseous fuel to be injected by port fuel injectors into a plurality of engine cylinders and an amount of a second, liquid fuel to be injected by direct fuel injectors into the plurality of engine cylinders, based at least in part on cylinder combustion conditions indicated by at least one combustion sensor and based on a power level setting. The control system is then further operable to change the amount of the first fuel injected in response to an indication of combustion condition in at least one of the plurality of cylinders, the change including decreasing the amount of the first fuel injected by the port fuel injectors and correspondingly increasing the amount of the second fuel injected by the direct fuel injectors.

FIG. 2 shows a detailed depiction of an engine system 200. In one example, engine system 200 is included in a vehicle system, such as the vehicle system of FIG. 1. Engine system 200 includes a control system 214, and a fuel system 218. The engine system 200 may include an engine 210 having a plurality of cylinders 230. The engine 210 includes an engine intake 223 and an engine exhaust 225. The engine intake 223 includes a throttle 262 fluidly coupled to the engine intake manifold 244 via an intake passage 242. The engine exhaust 225 includes an exhaust manifold 248 leading to an exhaust passage 235 that routes exhaust gas to the atmosphere upon passage through an emission control device 270. It will be appreciated that other components may be included in the engine such as a variety of valves and sensors.

Engine system 200 is shown as a boosted engine system including a turbocharger having a compressor 272 driven by an exhaust turbine 274. By operating the turbocharger, a boosted engine operation is enabled. In alternate embodiments, engine system 200 may be configured with a supercharger. Engine system is also shown including an EGR system for recirculating an amount of exhaust gas from the engine exhaust to the engine intake. Specifically, engine system 200 is shown with an EGR passage 295 coupled upstream of compressor 272 and downstream of turbine 274. By adjusting a position of EGR valve 296 in EGR passage 295, an amount of low pressure EGR can be provided. In other embodiments, high pressure EGR may also be enabled wherein the EGR passage is coupled downstream of compressor 272 and upstream of turbine 274.

Fuel system 218 includes one or more fuel tanks. In the depicted example, the fuel system is a multi-fuel system including a first fuel tank 220a configured to deliver a first fuel having a first chemical and physical property along a first fuel line 252, and a second fuel tank 220b configured to deliver a second fuel having a second, different chemical and physical property along a second fuel line 254. Various fuel system components, such as various valves, pressure regulators, filters, and sensors, are coupled along each of first fuel line 252 and second fuel line 254. Fuel tanks 220a, 220b hold a plurality of fuel or fuel blends. For example, the first fuel stored in the first fuel tank 220a may be a first gaseous fuel, such as compressed natural gas (CNG) while the second fuel stored in the second fuel tank 220b may be a second liquid fuel, such as diesel. In one example, as shown in FIG. 1, engine 210 may be housed on a first vehicle of a vehicle system while first fuel tank 220a storing the first, gaseous fuel may be housed on a second vehicle of the vehicle system, the second vehicle mechanically coupled to the first vehicle. The second fuel tank 220b storing the second, liquid fuel may be housed with the engine on the first vehicle of the vehicle system.

Each fuel tank may be coupled to respective fuel pumps for pressurizing fuel delivered to the injectors of engine 210, such as example injectors 266 and 268. While only a single set of injectors 266, 268 are depicted, additional sets of injectors are provided for each cylinder 230. In the depicted example, the first fuel stored in first fuel tank 220a is delivered to a first, port fuel injector 266 of engine cylinder 230 via a first fuel rail 223a while the second fuel in second fuel tank 220b may be delivered to a second, direct injector 268 of engine cylinder 230 via a second fuel rail 223b. However, in alternate examples, each of injectors 266, 268 may be configured as direct injectors, wherein each of the first fuel and the second fuel are delivered to the engine cylinder via direct fuel injection. Alternatively, each of injectors 266, 268 may be configured as port injectors, wherein each of the first fuel and the second fuel are delivered to the engine cylinder via port fuel injection. The fuel system may further include one or more valves (not shown) to regulate the supply of fuel from fuel tank 220a to injector 266 and from fuel tank 220b to injector 268.

In the depicted example, first fuel line 252, and related components are configured to deliver the first gaseous fuel. Accordingly, first fuel tank 220a is coupled to a pressure regulator 234 and a solenoid valve 236 to enable a fixed low pressure supply of the first fuel to be provided to injector 266. A tank valve 232 (e.g., a check valve) is positioned between first fuel tank 220a and pressure regulator 234 to ensure correct flow of fuel from the fuel tank. A tank output line pressure sensor 233 is positioned upstream of pressure regulator 234 and downstream of first fuel tank 220a to provide an estimate of fuel pressure before pressure regulation by pressure regulator 234. For example, pressure sensor 233 may provide an estimate of fuel pressure input on the higher pressure side of pressure regulator 234. A coalescing filter 238 is positioned on the lower pressure side of pressure regulator 234. Solenoid valve 236, also referred to as a lock-off valve, may be coupled between pressure regulator 234 and coalescing filter 238.

In one example, first fuel tank 220a stores the first gaseous fuel in a pressure range of 10-220 bar (e.g., 3000-6000 psi for CNG fuel) while pressure regulator 234 regulates the fuel rail pressure to a fixed range of 3-10 bar (e.g., 2-10 bar for CNG fuel). A further check valve (not shown) may be coupled downstream of pressure regulator 234 and upstream of fuel injector 266. As such fuel system 218 may be a return-less fuel system, a return fuel system, or various other types of fuel system. It will be appreciated that while the embodiment shows fuel system 218 as a bi-fuel system, in alternate embodiments, fuel system 218 may include further additional fuels.

Engine system 200 further includes control system 214. Control system 214 is shown receiving information from a plurality of sensors 216 (various examples of which are described herein) and sending control signals to a plurality of actuators 281 (various examples of which are described herein). As one example, sensors 216 may include MAP and MAF sensors 284 and 285 in the intake, exhaust gas sensor 286 and temperature sensor 227 located in the exhaust, pressure sensors 202, 204 coupled to first and second fuel rails respectively and configured to provide an estimate of the respective fuel rail pressures, pressure sensors 292, 294 coupled to first and second fuel tanks respectively and configured to provide an estimate of the respective fuel tank pressures, etc. Other sensors such as pressure, temperature, fuel level, air/fuel ratio, and composition sensors may be coupled to various locations in the engine system. For example, a combustion sensor 228 and a crankshaft speed sensor (not shown) may be coupled to an engine block to provide an indication of cylinder combustion conditions. For example, combustion sensor 228 may provide an indication regarding uncontrolled combustion in a cylinder based on block vibration signals during predefined windows of crankshaft angle. As another example, the actuators may include fuel pumps (221a and 221b), fuel injectors 266, 268, solenoid valve 236, pressure regulator 234, and throttle 262. The control system 214 may include a controller 212 that receives input data from the various sensors, processes the input data, and triggers the actuators in response to the processed input data.

In one example, the controller may receive information of cylinder combustion conditions of plural cylinders of an engine and port injecting respective first amounts of a first, gaseous fuel into the cylinders during intake strokes of the cylinders while direct injecting respective second amounts of a second, liquid fuel into the cylinders. The controller may then control the first amounts and the second amounts based on the information of the cylinder combustion conditions that is received.

Now turning to FIG. 3, an example routine 300 is provided for adjusting an amount of a first gaseous fuel and/or an amount of a second liquid fuel that is delivered to a cylinder of a vehicle engine in response to an indication of uncontrolled combustion in the engine cylinder. The adjustment enables mitigation of uncontrolled combustion of a relatively homogenous mixture of air and the first fuel in the cylinder that is onset by combustion of a stratified mixture of air and the second fuel in the cylinder.

At 302, engine and vehicle operating conditions are estimated and/or measured. These include, for example, engine speed, vehicle speed, engine temperature, exhaust catalyst temperature, ambient conditions (e.g., ambient temperature, ambient humidity, ambient soot or dust levels, barometric pressure, altitude, etc.), boost level, desired power level, operator torque demand, etc.

At 304, based on the estimated operating conditions, injection amounts for a first, gaseous fuel and a second, liquid fuel are determined. For example, a vehicle control system may be operable to determine a first amount of the first fuel and a second amount of the second fuel. The control system may also determine a ratio of the first fuel to the second fuel in a total fuel amount.

As such, the first fuel may be a first non-compression ignitable fuel. For example, a relatively homogenous mixture of the first fuel and air in the cylinder may be ignited by operating a spark plug. The first fuel may comprise a gaseous fuel, such as natural gas (e.g., compressed natural gas (CNG), liquefied natural gas (LNG), etc.). As used herein, a gaseous fuel refers to a fuel that is gaseous at atmosphere conditions but may be in liquid form while at high pressure (specifically, above saturation pressure) in the fuel system. In other words, the first fuel is injected into the engine (at lower pressure) in gaseous form but is stored and delivered (at higher pressure) in liquid form. In one example, as depicted at FIG. 1, the vehicle engine may be located inside a first vehicle and the first fuel may be stored in a second vehicle mechanically coupled to the first vehicle. In comparison, the second fuel is a second compression ignitable fuel. For example, a stratified charge mixture of the second fuel and air in the cylinder is ignited towards the top of compression stroke using the heat of compression in the cylinder. The second fuel may comprise a liquid fuel, such as diesel.

The first and second fuel amounts to be injected into the engine cylinders may be based at least in part on a power level setting of the engine. The fuel amounts may also be based at least in part on cylinder combustion conditions indicated by at least one combustion sensor. As an example, where the engine is located inside a rail vehicle, a desired power level (or operated torque demand) may be inferred from a power level setting, such as a notch setting of a notched throttle of the rail vehicle, as set by a vehicle operator. The control system may determine an initial fuel injection ratio with unadjusted amounts of the first gaseous fuel and the second, liquid fuel for injection into a cylinder, based on the power level setting of the vehicle, prior to receiving any indication of uncontrolled combustion.

At 306, the routine includes delivering the first fuel to an engine cylinder at least partially during an intake stroke. The first fuel delivered to the engine cylinder may comprise a gaseous fuel such as CNG. Delivering the first fuel includes delivering the first, gaseous fuel. Delivering the first fuel to the cylinder may further include port injecting the first fuel into the cylinder. The control system may port inject the first amount of the first non-compression ignitable (gaseous) fuel into the engine cylinder at least partially during an intake stroke (e.g., earlier during an intake stroke) to provide a relatively homogenous mixture (or charge) of the first fuel and air in the cylinder. For example, the first gaseous fuel may be inducted together with air at least partially during the intake stroke. As an example, the first fuel and air may be pre-mixed for approximately 10 CAD to provide the relatively homogenous mixture. While the above example suggests port injecting the first fuel, it will be appreciated that delivering the first fuel may alternatively include direct injecting the first gaseous fuel at least partially during the intake stroke.

Next at 308, the routine includes initiating combustion in the cylinder via stratified injection of the second (liquid) fuel into the cylinder. The second fuel is injected during a compression stroke, such as at compression stroke TDC. Delivering the second fuel to the cylinder includes direct injecting the second fuel into the cylinder. Specifically, the control system may direct inject the second amount of the compression ignitable second (liquid) fuel into the cylinder to provide a stratified mixture (or charge) of the second fuel and air in the cylinder. Once combustion of the second fuel is initiated via the compression ignition, the initiated combustion of the stratified cylinder charge (composed of second fuel and air) may then initiate combustion of the homogenous cylinder charge (composed of first fuel and air). The second fuel injected for initiating combustion in the cylinder may comprise a liquid fuel such as diesel.

During some engine operating conditions, uncontrolled combustion of the homogenous cylinder charge may be onset by the initiated combustion of the second fuel. The uncontrolled combustion includes auto-ignition of end gasses in the cylinder, which may include a mixture of the first fuel and air. The auto-ignition is caused by compression ignition stratified combustion of the second fuel. For example, compression ignition stratified combustion of liquid fuel may generate a primary flame front that increases pressure and temperature of remaining end gasses (including a mixture of air and the fist, gaseous fuel) in the cylinder to the point of auto-ignition. The resulting flame front of the end gasses then collides with the primary flame front and generates noise and vibration, as well as reduced engine torque for a given amount of the fuels. Therefore, if left unmitigated, the uncontrolled combustion can lead to a loss of engine power. Accordingly, at 310, the routine determines if there is an indication of uncontrolled combustion of the homogenous mixture of first fuel and air in any cylinder. In one example, one or more sensors (e.g., combustion sensors) may be coupled to a body of the engine for indicating cylinder combustion conditions. Based on the output of the one or more sensors relative to a threshold, uncontrolled combustion may be determined. For example, if the output of the one or more sensors is higher than the threshold, uncontrolled combustion may be confirmed. In addition, based on an output from a crankshaft speed sensor (coupled to an engine block) relative to the cylinder combustion indication from the one or more (combustion) sensors, the identity of a cylinder (or cylinders) in which the uncontrolled combustion has occurred may be determined.

If no indication of uncontrolled combustion is received, the routine may end with the control system injecting the determined (unadjusted) amounts of the first and second fuel into the engine. As such, the unadjusted amounts are injected before an indication of uncontrolled combustion is received. If uncontrolled combustion is indicated based on the output from each of a combustion sensor and a crankshaft speed sensor coupled to an engine block of the vehicle, then at 312, the routine includes adjusting amounts of the first, gaseous fuel and the second fuel in the cylinder. For example, the fuel injection amounts are adjusted responsive to a first indication of uncontrolled combustion of pre-mixed first, gaseous fuel and air in the cylinder, the uncontrolled combustion onset by the initiated combustion of the second fuel (that was injected via stratified injection). The adjusting includes changing the amount of first fuel injected and changing the amount of second fuel injected into a cylinder in response to the first indication of uncontrolled combustion in the given cylinder while maintaining the cylinder output torque and while also maintaining a cylinder air-to-fuel ratio at a level where there is relatively more air (e.g., more in weight, more in volume, etc.) than total fuel present to consume the air during combustion of the total fuel amount. For example, the cylinder air-to-fuel ratio may be maintained leaner than stoichiometry. The adjustment at 312 may include, decreasing an injection amount of the first, gaseous fuel at 313 and increasing an injection amount of the second, liquid fuel at 314, in corresponding amounts. For example, the amount of decrease in the first fuel may be compensated by the amount of increase in the second fuel. While the actual mass amounts of the first fuel's decrease and the second fuel's increase may be different (due to the different stoichiometric combustion ratios of the first and second fuels) the amounts may be selected to maintain the overall combustion torque level. For example, at current operating conditions, a pre-stored ratio may be used that provides a relatively constant torque level with corresponding decreases/increases in the respective first and second fuels.

In one example, decreasing an injection amount of the first fuel includes maintaining a start of injection timing of the first fuel while advancing an end of injection timing of the first fuel so as to decrease an overall duration of injection of the first fuel. Likewise, increasing an injection amount of the second fuel includes maintaining a start of injection timing of the second fuel while retarding an end of injection timing of the second fuel so as to increase an overall duration of injection of the second fuel. However, in some embodiments, the start of injection timing of the second fuel may also be adjusted, as elaborated at FIG. 4. Therein, increasing an injection amount of the second fuel may further include adjusting an injection timing of the stratified fuel injection to be later, with respect to a crankshaft position, in response to the indication of uncontrolled combustion. For example, the injection timing (for example, start of injection timing) of the second fuel may be retarded from earlier in the compression stroke towards later in the compression stroke, or from the compression stroke to the expansion stroke.

In one embodiment, the controlling of the first and second fuel injection amounts in response to the indication of uncontrolled combustion is selectively performed on a cylinder-by-cylinder basis on one or more engine cylinders in which uncontrolled combustion was indicated. For example, the adjusting of fuel injection amounts is performed only in those cylinders that are determined to be affected by the uncontrolled combustion. However, in alternate embodiments, if the indication of uncontrolled combustion is higher than an upper threshold, the adjustment may be extended to all engine cylinders, including those not determined to be affected by the uncontrolled combustion, so as to mitigate potential uncontrolled combustion in those cylinders (for example, in anticipation of potential uncontrolled combustion events).

In some embodiments, the fuel injection amounts may be further adjusted based on the vehicle operating in a defined condition. Therein, when the vehicle begins operating in the defined condition (e.g., when the vehicle has just started operating in the defined condition), or is about to begin operating in the defined condition (e.g., when the vehicle is a threshold distance or time away from operating in the defined condition), the control system may further change the amount of first fuel and/or second fuel in anticipation of uncontrolled cylinder combustion events. Then, when the defined condition ends, the initial (that is, unadjusted) fuel injection amounts can be resumed. As an example, in response to a location of the vehicle relative to a tunnel (e.g., the vehicle being in a tunnel or the vehicle approaching a tunnel and being less than a threshold distance or duration away from entering the tunnel), the fuel amounts may be adjusted. The adjusting may include further decreasing the injection amount of the first fuel and/or further increasing the injection amount of the second fuel. As such, when the vehicle enters a tunnel, an amount of fresh intake air available to the engine may be limited and an amount of exhaust gas recirculation may be artificially raised (due to vehicle exhaust being drawn into the intake passage of the engine while the vehicle is travelling in the tunnel). Herein, in anticipation of potential uncontrolled combustion events arising from the temporary increase in external exhaust gas recirculation and temporary decrease in fresh air availability, the fuel injection amounts are adjusted.

As another example, the defined vehicle operating condition responsive to which the fuel injection amounts are adjusted may include a change in altitude and/or barometric pressure. Herein, as the vehicle reaches an uphill segment or a downhill segment, the injection amounts may be appropriately adjusted, the directionality of the adjustment based on whether the vehicle is travelling uphill or downhill. Still other defined vehicle operating conditions responsive to which the fuel injection amounts can be adjusted include changes in ambient temperature (e.g., vehicle operating in a warmer or cooler region), changes in ambient soot or dust levels (e.g., vehicle operating in a dustier region), etc.

In this way, by controlling the first and/or second fuel injection amounts while maintaining a cylinder output torque in response to an indication of uncontrolled combustion of a relatively homogenous charge mixture (of a first gaseous fuel and air) onset by compression ignition of a stratified charge mixture (of a second liquid fuel and air), uncontrolled combustion may be better mitigated and engine performance with the first gaseous fuel is improved.

Now turning to FIG. 4, another example routine 400 is shown for varying fuel injection adjustments responsive to an indication of uncontrolled cylinder combustion based on an intensity (e.g., magnitude) of the indication. By adjusting one or more engine operating parameters in addition to cylinder fuel injection amounts as the indication of uncontrolled combustion exceeds progressively higher thresholds, the uncontrolled combustion can be better mitigated. In addition, the likelihood of further uncontrolled combustion events can be reduced.

At 402, the routine includes confirming that there is an indication of uncontrolled combustion. As previously elaborated with reference to FIG. 3, an indication of uncontrolled combustion, as well as an identity of the affected cylinder(s) can be determined based on each of a combustion sensor output and a crankshaft speed sensor output. If uncontrolled combustion in a cylinder is confirmed, then at 404, the routine includes determining if the indication of uncontrolled combustion is higher than a first threshold (threshold1). For example, an absolute magnitude of the indication of uncontrolled combustion (such as, the sensor output) is compared to the first threshold. If the indication is not higher than the first threshold, then at 406, the routine includes adjusting the first and second fuel injection amounts to the affected cylinder. As elaborated at FIG. 3, a first fuel amount delivered to the affected cylinder is decreased while a second fuel amount delivered to the affected cylinder is correspondingly increased so as to mitigate the uncontrolled combustion while maintaining a cylinder output torque and air-to-fuel ratio. This includes maintaining a start of injection timing for both the first and second fuels but advancing an end of injection timing of the first fuel (so as to decrease an injection duration of the first fuel) while retarding the end of injection timing of the second fuel (so as to increase an injection duration of the second fuel).

If the indication is higher than the first threshold at 404, then at 408, it may be further determined if the indication is higher than a second threshold (threshold2), wherein the second threshold is higher than the first threshold. For example, the absolute magnitude of the indication of uncontrolled combustion (such as, the sensor output) is compared to the second threshold. If the indication is higher than the first threshold but not higher than the second threshold, then at 410, the routine includes adjusting the first and second fuel injection amounts to the affected cylinder (as discussed above at 406) while also retarding an injection timing of the second fuel to be later with respect to a crankshaft position. For example, in addition to decreasing first fuel injection and increasing second fuel injection, an injection timing of the second fuel is retarded from earlier in the compression stroke to later in the compression stroke (or into the expansion stroke). Specifically, in addition to adjustments to end of injection timing for each of the first and second fuel (as discussed above at 406), a start of injection timing for the second fuel is retarded while the start of injection timing of the first fuel is maintained.

If the indication is higher than each of the first and second thresholds, then at 412, the routine includes, in addition to adjusting the first and second fuel injection amounts and retarding the injection timing of the second fuel (as discussed above at 410), adjusting one or more other engine operating parameters. For example, if the engine is operating with boost, a boost level is decreased. As another example, if the engine is operating with EGR, the EGR level is decreased. This may include adjusting a valve position of an EGR valve to decrease an amount of exhaust gas recirculated from the engine exhaust to the engine intake via an EGR passage (such as the EGR valve and passage of FIG. 2).

It will be appreciated that while the routine of FIG. 4 shows the controlling of the first and second fuel injection amounts in response to the indication of uncontrolled combustion being selectively performed on a cylinder-by-cylinder basis on the affected cylinder(s) where uncontrolled combustion was indicated, in some embodiments, when the indication of uncontrolled combustion is higher than the first threshold and/or the second threshold, the adjustment may be extended to all engine cylinders, including those not determined to be affected by the uncontrolled combustion, in anticipation of potential uncontrolled combustion events. For example, at 410 and/or 412, the fuel injection amount adjustment and fuel injection timing adjustment may be extended to unaffected cylinders. In still further embodiments, the number of unaffected cylinders to which the adjustments are extended can be adjusted based on a difference between the indication of uncontrolled combustion and the first and/or second thresholds. Thus, as the indication of uncontrolled combustion exceeds the first and/or second threshold, a number of unaffected cylinders to which the adjustments are extended may be increased.

In one example, a vehicle system (e.g., a train) includes a first vehicle (e.g., a locomotive) mechanically coupled to a second fuel storage vehicle (e.g., a tandem car). The first vehicle houses a vehicle engine that is operable with a first, gaseous fuel (e.g., operable on compressed natural gas (CNG)) as well as a second liquid fuel (e.g., diesel). The second vehicle houses a fuel tank storing the first gaseous fuel under higher pressure, the fuel deliverable and used in the engine on the first vehicle at lower pressure. Based on engine operating conditions including a power setting (e.g., a notch setting) of the engine, an engine controller estimates a first fuel amount of the first, CNG fuel and a second fuel amount of the second, diesel fuel for injection into each cylinder. The CNG fuel is port injected earlier in an intake stroke to allow sufficient air-fuel mixing in the cylinder and generation of a homogeneous air-charge mixture. Then, in the compression stroke, the diesel fuel is injected (e.g., as a cylinder piston approaches TDC) to generate a stratified air-charge mixture. Compression ignition of the stratified air-charge mixture then initiates combustion of the pre-mixed homogenous air-charge mixture.

During selected conditions, the stratified combustion of the diesel fuel can lead to uncontrolled combustion of the homogenous air-charge mixture (comprising the CNG fuel). In response to an indication of uncontrolled combustion, as detected by combustion sensors couplable to the engine block, an engine controller immediately adjusts the first and second fuel injection amounts in the uncontrolled combustion affected cylinder(s). Specifically, the amount of CNG fuel injected is reduced and the amount of diesel fuel injected is correspondingly increased. The fuel injection adjustment is continued until the indication of uncontrolled combustion has subdued.

Now turning to FIG. 5, an alternate embodiment of an engine system 502 coupled to a vehicle 500 is shown. Vehicle 500 may include a locomotive, marine vessel, Off-Highway Vehicle (OHV), etc., as non-limiting examples. The engine system 502 includes a plurality of cylinders 504. The plurality of cylinders 504 are organized into one or more donor cylinder groups and one or more non-donor cylinder groups. In particular, the engine system 502 includes a first cylinder group 506 that includes at least a first cylinder and a second cylinder group 508 that includes at least a second cylinder. Note that “first” and “second” are labels to denote the cylinders of the first and second cylinder groups, respectively.

The first cylinder group 506 includes at least one donor cylinder that provides exhaust gas that is directed to an intake manifold 510 of the engine system 502. (Intake manifold refers to a passage or passages that link to cylinder input ports for providing intake air to the cylinders.) The second cylinder group 508 includes at least one non-donor cylinder that provides exhaust gas that is directed to an exhaust pipe 514. In the illustrated implementation, the first cylinder group 506 includes one donor cylinder that only provides exhaust gas to the intake manifold 510 and the second cylinder group 508 includes three non-donor cylinders that only provide exhaust gas to the exhaust pipe 514. It will be appreciated that each of the cylinder groups may include any suitable number of cylinders. Furthermore, the engine system may include any suitable number of donor cylinder groups and non-donor cylinder groups. In some implementations, a donor cylinder group may selectively provide exhaust gas to an intake manifold and an exhaust pipe through operation of a valve or another control device.

The intake manifold 510 couples to the first cylinder group 506 and the second cylinder group 508. An intake passage 512 supplies fresh air to the intake manifold 510 for combustion. In particular, air enters the intake passage 512 from the environment and passes through a compressor 516 of a turbocharger 520. In the illustrated implementation, the engine system 502 does not include a throttle valve positioned in the intake passage 512. However, in some implementations, the intake passage 512 may include a throttle valve positioned downstream of the compressor 516.

The turbocharger 520 includes the compressor 516, which is coupled to a turbine 518. The turbine 518 is positioned in the exhaust pipe such that exhaust gas provided by the second cylinder group 506 causes the turbine 518 to rotate. Rotation of the turbine 518 drives the compressor 516, compressing air passing through the intake passage 512 to increase the mass of air flowing or boost pressure in the intake manifold 510.

Each of the plurality of cylinders 504 includes at least one intake port 522 that is operable to receive combustion air from the intake manifold 510 and at least one exhaust port 524 that is operable to exhaust gas to an exhaust manifold. A first exhaust manifold 526 is coupled to the first cylinder group 506 to receive exhaust gas from the first cylinder group 506. The first exhaust manifold 526 is not coupled to the second cylinder group 508. An EGR passage 530 is coupled between the first exhaust manifold 526 and the intake passage 512. EGR gas flows through the EGR passage 530 into the intake passage 512, where it mixes with fresh intake air and the mixed air is compressed by the compressor 516. The EGR gas and fresh air mixture flows through the intake manifold 510 and is directed to the first cylinder group 506 and the second cylinder group 508. The EGR passage 530 is not coupled to the second exhaust manifold 528 of the second cylinder group 508. In some implementations, an EGR valve is positioned in the EGR passage 530 to control EGR mass flow rate through the EGR passage in addition to controlling EGR composition through active fuel control of the donor cylinder group. In some implementations, the EGR passage 530 does not include an EGR valve or other device to vary a flow rate of EGR gas provided to the intake manifold 510.

A second exhaust manifold 528 is coupled to the second cylinder group 508 to receive exhaust gas from the second cylinder group 508. The second exhaust manifold 528 is not coupled to the first cylinder group 506. The second exhaust manifold 528 couples to the exhaust pipe 514. Exhaust gas provided by the second cylinder group 508 travels from the second exhaust manifold 528, through the turbine 518 of the turbocharger 520, to the exhaust pipe 514. Various after-treatment devices (not shown) can be provided in the exhaust pipe 514, before and after the turbine 518, to treat the exhaust gas before it is released to the atmosphere.

A first set of fuel injectors 532 are shown coupled directly to the plurality of cylinders 504 for injecting fuel directly therein in proportion to a pulse width of signals from a controller 534. In this manner, the plurality of fuel injectors 532 provides what is known as direct injection of fuel into the plurality of cylinders 504. In addition, a second set of fuel injectors 533 are shown coupled to an intake port of the plurality of cylinders 504 for injecting fuel into the intake port of each cylinder in proportion to a pulse width of signals from a controller 534. In this manner, the plurality of fuel injectors 533 provides what is known as port injection of fuel into the plurality of cylinders. Each of the plurality of fuel injectors 532, 533 is independently operable to inject fuel into one of the plurality of cylinders 504. Each of a first fuel, such as a first gaseous fuel, and a second fuel, such as a second, liquid fuel may be routed to the cylinders via the plurality of fuel injectors 532, 533 by a fuel system (not shown) including a fuel tank, a fuel pump, and a fuel rail. In one example, as previously elaborated with reference to FIG. 2, controller 534 may port inject the first (gaseous) fuel and direct inject the second (liquid) fuel to the cylinders.

The controller 534 receives various signals from sensors 540 coupled to the engine system 502. The controller 534 may be configured to control EGR based at least in part on the signals. For example, the controller 534 receives sensor signals indicative of air-fuel ratio, engine speed, engine load, engine temperature, ambient temperature, intake manifold temperature, exhaust temperature, intake manifold pressure (boost pressure), exhaust pressure, ambient altitude, intake manifold oxygen concentration, uncontrolled cylinder combustion, etc. In the illustrated implementation, the controller 534 is a computing device, such as microcomputer that includes a processor unit 536, non-transitory computer-readable storage medium device 538, input/output ports, memory, a data bus, etc. Computer-readable storage medium device 538 is programmable with computer readable data representing instructions executable by the processor unit for performing the methods described below as well as other variants that are anticipated but not specifically listed.

The controller 534 is operable to adjust various actuators in the engine system 502 based on different operating parameters received or derived from different signals received from the plurality of sensors 540. For example, the controller 534 is operable to determine a designated oxygen concentration in the donor cylinder group. The designated oxygen concentration may be a predicted or target oxygen concentration that is achieved through feedback control. The designated oxygen concentration may be determined in any suitable manner. For example, various operating conditions based on engine speed, engine load, engine temperature, boost pressure, etc. can be mapped (e.g., in a look-up table) to a designated oxygen concentration that is provided to all of the engine cylinders. Further, the controller 534 is operable to determine an actual oxygen concentration in donor cylinders and/or non-donor cylinders of the engine during combustion. The actual oxygen concentration may be determined in any suitable manner. For example, an oxygen sensor that is located in the intake manifold may provide a sensor signal to the controller 534 that is indicative of the actual oxygen concentration. As another example, the actual oxygen concentration may be derived from other operation parameters.

The controller 534 is operable to adjust a donor cylinder fuel injection amount to drive the actual oxygen concentration to the designated oxygen concentration, and adjust a non-donor cylinder fuel injection amount dependent upon the donor cylinder fuel injection adjustment and to maintain another, second operating parameter. In one example, the controller 534 is operable to adjust the non-donor cylinder fuel injection amount to a designated torque output provided by the donor cylinders and the non-donor cylinders. In another example, the controller 534 is operable to adjust the non-donor cylinder fuel injection amount to achieve or obtain a designated air fuel ratio provided by the non-donor cylinders. In another example, the controller 534 is operable to adjust the non-donor cylinder fuel injection amount based on a designated boost pressure. Since the turbine 518 of the turbocharger 520 is positioned in the exhaust pipe 514 that is fluidly connected to the non-donor cylinder group, air-fuel ratio and boost pressure can be control targets for actively controlling the non-donor cylinder fuel injection amount.

In some implementations, the controller 534 is operable to enable differential fueling between the donor cylinders and the non-donor cylinders. The differential fuel amount is a ratio representative of an amount of total fuel (including a first amount of the first fuel and a second amount of the second fuel) provided to a single active donor cylinder and an amount of fuel provided to a single active non-donor cylinder. The differential fuel amount can be applied to a designated total fuel amount to determine how much of each fuel is provided to the donor cylinder and non-donor cylinders. Note that by adjusting the differential fuel amount the total amount of net fuel may not change, instead the distribution of that total fuel amount between the donor cylinders and non-donor cylinders changes. For example, as elaborated with reference to routine of FIG. 6, the controller 534 is operable to adjust a differential total fuel injection amount between a donor cylinder total fuel injection amount and a non-donor cylinder total fuel injection amount responsive to an indication of uncontrolled cylinder combustion. In particular, the controller 534 is operable to adjust an amount of first fuel and/or second fuel injected into each of a non-donor cylinder and a donor cylinder in response to an indication of uncontrolled combustion in a non-donor cylinder, while adjusting an amount of first fuel and second fuel injected into a donor cylinder only in response to an indication of uncontrolled combustion in the donor cylinder. It will be appreciated that all fuel injection adjustments (to donor and non-donor cylinders) are performed to allow a net engine output torque to be maintained.

For example, in response to a first indication of uncontrolled combustion in a cylinder of the donor cylinder group, an injection amount of the second fuel is increased and an injection amount of the first fuel is decreased in the affected donor cylinder. At the same time, first and second fuel injection amounts in the non-donor cylinder group are maintained so as to maintain the output torque of the vehicle engine. In comparison, in response to a second indication of uncontrolled combustion in a cylinder of the non-donor cylinder group, an injection amount of first fuel to the affected donor cylinder is decreased while maintaining an injection amount of the second fuel in the affected donor cylinder. At the same time, an injection amount of the first and/or second fuel is correspondingly increased in a cylinder of the donor cylinder group so as to maintain the output torque of the vehicle engine.

In this way, by differentially adjusting fuel injection amounts, uncontrolled combustion in the affected cylinders is mitigated. In addition, by actively controlling the fuel injection amounts, the controller can control an EGR gas composition, which in turn also assists in uncontrolled combustion mitigation. Herein, the active fuel injection adjustment allows EGR to be varied without controlling an EGR flow rate through an EGR passage by varying an EGR valve position. However, in alternate embodiments, EGR rates may be additionally or optionally adjusted, in response to the uncontrolled combustion by varying a position of the EGR valve. For example, in response to uncontrolled combustion in a cylinder of the non-donor cylinder group, EGR via an EGR passage and an EGR valve may be increased.

Now turning to FIG. 6, an example routine 600 is shown for adjusting a first and second fuel injection amount to a cylinder of the engine system of FIG. 5 responsive to an indication of uncontrolled combustion. As shown herein, the fuel injection adjustment may be different based on whether the affected cylinder is a donor cylinder or a non-donor cylinder.

At 602, the routine includes determining if there is an indication of uncontrolled combustion in a cylinder of the non-donor cylinder group. As elaborated with reference to FIG. 3, an indication of uncontrolled combustion, as well as an identity of the affected cylinder(s) can be determined based on each of a combustion sensor output and a crankshaft speed sensor output. If uncontrolled combustion in a first, non-donor cylinder is confirmed, then at 604, the routine includes decreasing an injection amount of the first (gaseous) fuel and maintaining an injection amount of the second (liquid) fuel in the cylinder of the first non-donor cylinder group while increasing an injection amount of the first and/or second fuel in a cylinder of the second donor cylinder group to maintain the output torque of the vehicle engine. Herein, fuel injection adjustments are performed in both the donor cylinder and the non-donor cylinder in response to the uncontrolled combustion in the non-donor cylinder.

If uncontrolled combustion in a cylinder of the non-donor cylinder group is not confirmed, then at 606, uncontrolled combustion in a cylinder of the donor cylinder group may be confirmed based on each of the combustion sensor output and the crankshaft speed sensor output. Upon confirmation, at 608, responsive to the indication of uncontrolled combustion in a second, donor cylinder, the routine includes increasing an injection amount of the second fuel and decreasing an injection amount of the first fuel while maintaining output torque of the vehicle engine responsive to indication of uncontrolled combustion in a cylinder of the second donor cylinder group. Herein, fuel injection adjustments are only performed in the donor cylinder while the fuel injection amounts at the non-donor cylinder are maintained in response to the uncontrolled combustion in the non-donor cylinder.

In this way, by increasing the amount of second fuel that is injected into an engine cylinder and/or reducing the amount of first fuel that is injected into the cylinder, uncontrolled cylinder combustion of a mixture of air and a non-compression ignitable fuel that is onset by the combustion of a mixture of air and a compression ignitable fuel can be mitigated and engine performance is improved. By temporarily reducing usage of the first gaseous fuel while allowing the engine to continue operating with at last some gaseous fuel, fuel economy benefits from using the gaseous fuel are achieved while reducing the uncontrolled combustion.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

1. A method for a vehicle engine, comprising:
delivering a first fuel to an engine cylinder at least partially during an intake stroke;
initiating combustion in the cylinder via stratified injection of a second fuel into the cylinder; and
adjusting amounts of the first fuel relative to the second fuel in the cylinder responsive to a first indication of uncontrolled combustion of pre-mixed first fuel and air in the cylinder, the uncontrolled combustion onset by the initiated combustion of the second fuel.

2. The method of claim 1, wherein adjusting the amounts includes increasing an injection amount of the second fuel and decreasing an injection amount of the first fuel while maintaining output torque of the vehicle engine, and wherein the first fuel that is delivered to the engine cylinder comprises a gaseous fuel and the second fuel that is injected for initiating combustion in the cylinder comprises a liquid fuel.

3. The method of claim 2, wherein during the adjusting, an air-to-fuel ratio in the cylinder is maintained at a level where there is relatively more air than total fuel present to consume the air during combustion of the total fuel.

4. The method of claim 2, wherein increasing the injection amount of the second fuel includes adjusting an injection timing of the stratified injection later with respect to a crankshaft position of a crankshaft of the engine in response to the first indication of uncontrolled combustion.

5. The method of claim 2, wherein the vehicle engine is located inside a first vehicle and the first fuel is stored in a second vehicle mechanically coupled to the first vehicle.

6. The method of claim 2, wherein the gaseous fuel comprises compressed natural gas and the liquid fuel comprises diesel fuel.

7. The method of claim 2, wherein delivering the first fuel to the cylinder includes port injecting the first fuel into the cylinder, and stratified injection of the second fuel includes direct injecting the second fuel into the cylinder.

8. The method of claim 2, wherein unadjusted injection amounts of the first fuel and the second fuel that are injected before the first indication of uncontrolled combustion are based on a power level setting of the vehicle.

9. The method of claim 8, wherein the amounts of the first fuel relative to the second fuel in the cylinder that are adjusted responsive to the first indication of uncontrolled combustion are further adjusted in response to a location of the vehicle relative to a tunnel, the further adjusting including further decreasing the injection amount of the first fuel and/or further increasing the injection amount of the second fuel.

10. The method of claim 1, wherein the vehicle engine includes a first, non-donor cylinder group and a second, donor cylinder group, and adjusting the amounts of the first fuel relative to the second fuel responsive to the first indication of uncontrolled combustion includes increasing an injection amount of the second fuel and decreasing an injection amount of the first fuel while maintaining output torque of the vehicle engine responsive to the first indication of uncontrolled combustion occurring in a cylinder of the second, donor cylinder group.

11. The method of claim 10, further comprising, in response to a second indication of uncontrolled combustion occurring in a cylinder of the first, non-donor cylinder group, decreasing an injection amount of the first fuel and maintaining an injection amount of the second fuel in the cylinder of the first, non-donor cylinder group while increasing the injection amount of the first fuel and/or the injection amount of the second fuel in the cylinder of the second, donor cylinder group to maintain the output torque of the vehicle engine.

12. The method of claim 11, wherein the first and second indication of uncontrolled combustion is based on outputs from a combustion sensor and a crankshaft speed sensor coupled to an engine block of the vehicle engine.

13. A method, comprising:
port injecting a first amount of a non-compression ignitable first fuel into a cylinder of an engine during an intake stroke to provide a relatively homogenous mixture of the first fuel and air in the cylinder;
direct injecting a second amount of a compression ignitable second fuel into the cylinder to provide a stratified mixture of the second fuel and air in the cylinder; and
controlling first and second fuel amounts while maintaining cylinder output torque in response to an indication of uncontrolled combustion of the relatively homogenous mixture onset caused by compression ignition of the stratified mixture.

14. The method of claim 13, wherein the first and second fuel amounts injected are based at least in part on a power level setting of the engine.

15. The method of claim 14, wherein controlling the first and second fuel amounts includes decreasing the first fuel amount while increasing the second fuel amount, while maintaining the cylinder output torque and while also maintaining a cylinder air-to-fuel ratio at a level where there is relatively more air than total fuel present to consume the air during combustion of the total fuel amount.

16. The method of claim 13, wherein controlling of the first and second fuel amounts is selectively performed on a cylinder-by-cylinder basis on one or more engine cylinders in which uncontrolled combustion was indicated.

17. The method of claim 13, wherein the indication of uncontrolled combustion is based on outputs from a combustion sensor and a crankshaft speed sensor coupled to a body of the engine.

18. A first vehicle comprising:
an engine system disposed in the vehicle, and comprising an engine with a plurality of engine cylinders, each cylinder having at least one port fuel injector and at least one direct fuel injector;
at least one sensor couplable to a body of the engine for indicating cylinder combustion conditions; and
a control system operable to determine an amount of a first, gaseous fuel to be injected by the port fuel injectors into the cylinders and an amount of a second, liquid fuel to be injected by the direct fuel injectors into the cylinders, based at least in part on the cylinder combustion conditions that are indicated by the at least one sensor.

19. A vehicle system, comprising:
a first vehicle as recited in claim 18; and
a fuel storage vehicle coupled to the first vehicle,
wherein the fuel storage vehicle comprises a first fuel tank for storing the first, gaseous fuel, and the first vehicle comprises a second fuel tank for storing the second, liquid fuel, and wherein the vehicle system further comprises a fuel delivery line linking the first vehicle and the fuel storage vehicle for transfer of the first, gaseous fuel from the fuel storage vehicle to the first vehicle.

20. The vehicle system of claim 19, wherein the first fuel is compressed natural gas and wherein the second fuel is diesel.

21. The vehicle system of claim 20, wherein the control system is further operable to change the amount of the first fuel injected in at least one of the plurality of cylinders responsive to the combustion conditions indicated by the at least one sensor, the change including decreasing the amount of the first fuel injected by the port fuel injectors.

22. The vehicle system of claim 21, wherein the control system is further operable to,
when the vehicle system begins, or is about to begin, operating in a defined condition, further changing the amount of the first fuel injected in at least one of the plurality of cylinders in anticipation of uncontrolled cylinder combustion events; and
when the defined condition ends, resuming initial fuel injection amounts.

23. The vehicle system of claim 20, wherein the control system is further operable to change the amount of the second fuel injected in at least one of the plurality of cylinders responsive to the combustion conditions indicated by the at least one sensor, the change including increasing the amount of the second fuel injected by the direct injectors.

24. The vehicle system of claim 23, wherein increasing the amount of second fuel includes retarding a fuel injection timing of the second fuel towards an expansion stroke.

25. A method, comprising:
receiving information of cylinder combustion conditions of plural cylinders of an engine;
port injecting respective first amounts of a first, gaseous fuel into the cylinders during intake strokes of the cylinders;
direct injecting respective second amounts of a second, liquid fuel into the cylinders; and
controlling the first amounts and the second amounts based on the information of the cylinder combustion conditions that is received.
